(19) United States
(12) Patent Application Publication
(10) Pub. No.: US 2012/0021794 A1
(43) Pub. Date: Jan. 26, 2012

(54) METHODS FOR TRANSMITTING A SCANNING REQUEST BASED ON A MULTICARRIER SYSTEM

(75) Inventors: Xiaoqin Shen, Shenzhen (CN); Hao Wu, Shenzhen (CN)

(73) Assignee: ZTE Corporation, Shenzhen (CN)

(21) Appl. No.: 13/145,776

(22) PCT Filed: Sep. 29, 2009
(86) PCT No.: PCT/CN2009/074325

§ 371 Date: Jul. 21, 2011

(30) Foreign Application Priority Data
Jan. 22, 2009 (CN) 200910002487.6

(51) Int. Cl. H04W 36/00

(52) U.S. Cl. 455/515

(57) ABSTRACT

The present invention discloses a method for transmitting a scanning request based on a multicarrier system, wherein the method comprises: a terminal obtaining multicarrier information transmitted by a service base station; and when a handover is needed to be performed, the terminal transmitting a scanning request signaling to the service base station, to request for scanning carriers. By the above-mentioned process, the terminal can transmit the scanning request signaling as required to request for performing the handover within the base station.

### FIELD OF THE INVENTION

The present invention relates to the communication field, and in particular to methods for transmitting a scanning request based on a multicarrier system.

### BACKGROUND OF THE INVENTION

In the related art, a concept of multicarrier is introduced into a system in order to meet a requirement of high speed.

A base station can be configured with a plurality of carriers, and these carriers can be categorized into two categories: a full configuration carrier and a partial configuration carrier, wherein the full configuration carrier comprises system side information of all necessary synchronous channels, control channels and the like; and the partial configuration carrier may only comprise a data transmission channel, or only comprise some necessary control messages. Compared with the full configuration carrier, the partial configuration carrier may not contain the synchronous channels.

At a terminal side, carriers can be categorized into a primary carrier and a secondary carrier, wherein the primary carrier, which must be the full configuration carrier, is mainly used to interact control messages and/or data between the base station and the terminal, and may also be used for interaction of service processing and physics (PHY) control information or media access control (MAC) information. In addition, the primary carrier may also be used to carry out part of terminal control functions (e.g. network access). It should be noted that each terminal only has one master carrier.

The secondary carrier may be the full configuration carrier or the partial configuration carrier. The secondary carrier is an additional carrier for transmitting services for the terminal, and is mainly used for interacting data, wherein the secondary carrier may also comprise control signalings which support multicarrier operation. One terminal may have a plurality of secondary carriers, and may also have no secondary carrier.

In a mobile communication system, when the terminal moves to a border of range of the base station, if a signal condition of the original service base station is reduced and the original service base station can not continuously provide services for the terminal, the terminal needs to handover to another base station to maintain continuity of the services. The handover is called as the handover between the base stations.

In a multicarrier system, since one base station provides a plurality of carriers, when quality of service (QoS) is reduced or signal intensity of a service carrier is reduced due to excessive load of the carrier (service carrier) being used by the terminal so that the terminal needs to search carriers with better intensity, the terminal can handover to other carriers in the base station to transmit data. The handover is called as the handover within the base station.

In a single-carrier system, the base station broadcasts information of adjacent cells (the cells which are adjacent to current service cell) via broadcast information to support scan to the adjacent cells by the terminal, so that the terminal can determine quality of signals of the adjacent cells, wherein the broadcast information may provide information such as base station identifications of the adjacent cells. In the multicarrier system, one base station is configured with a plurality of carriers, and the base station can broadcast multicarrier information of the service base station and the adjacent base station(s) via the broadcast information. However, in the related art, when the service carrier can not provide good wireless conditions for the terminal, the terminal has no related solution to transmit a scanning request to the service base station to request for scanning the carriers of the base station.

### SUMMARY OF THE PRESENT INVENTION

The present invention is proposed considering the problem in the related art that a terminal in a multicarrier system has no related solution to transmit a multicarrier scanning request to a base station. Therefore, the main object of the present invention is to provide an improved solution for transmitting the scanning request based on the multicarrier system, so as to solve the above problem in the related art.

In order to achieve the above-mentioned object, a method for transmitting a scanning request based on a multicarrier system is provided according to one aspect of the present invention.

The method for transmitting the scanning request based on the multicarrier system according to the present invention comprises: a terminal obtaining multicarrier information of a service base station transmitted by the service base station; and when a carrier handover within a base station is needed to be performed, the terminal transmitting a scanning request signaling to the service base station, to request for scanning carriers of the service base station.

In the above, the step that the terminal requests for scanning the carriers of the service base station comprises: the terminal requesting for scanning all the carriers in the service base station; or the terminal requesting for scanning full configuration carriers in the service base station.

In the above, the scanning request signaling carries at least one of the followings: scan duration, interleaving interval, scan iteration, a number index of recommended carriers, bitmap size of the carriers, a bitmap index of the carriers, and an index of the carriers.

In order to achieve the above-mentioned object, a method for transmitting a scanning request based on a multicarrier system is provided according to another aspect of the present invention.

The method for transmitting the scanning request based on the multicarrier system according to the present invention comprises: a terminal obtaining multicarrier information of adjacent base station(s) of a service base station transmitted by the service base station; and when a handover between base stations is needed to be performed, the terminal transmitting a scanning request signaling to the service base station, to request for scanning carriers of the adjacent base station(s).

In the above, the step that the terminal requests for scanning the carriers of the adjacent base station(s) comprises: the terminal requesting for scanning all the carriers in the adjacent base station(s); or the terminal requesting for scanning full configuration carriers in the adjacent base station(s).

In the above, the scanning request signaling carries at least one of the followings: scan duration, interleaving interval, scan iteration, a number index of recommended carriers, bitmap size of the carriers, a bitmap index of the carriers, and an index of the carriers.

In order to achieve the above-mentioned object, a method for transmitting a scanning request based on a multicarrier system is provided according to another aspect of the present invention.

The method for transmitting the scanning request based on the multicarrier system according to the present invention comprises: a terminal obtaining multicarrier information transmitted by a service base station; and when a handover is needed to be performed, the terminal transmitting a scanning request signaling to the service base station, to request for scanning carriers.

In the above, the step that the terminal obtaining the multicarrier information transmitted by the service base station comprises: the terminal obtaining the multicarrier information of the service base station transmitted by the service base station; and/or the terminal obtaining the multicarrier information of adjacent base station(s) of the service base station transmitted by the service base station.

In the above, the step of when the handover is needed to be performed, the terminal transmitting the scanning request signaling to request for scanning the carrier comprises: when the handover within a base station is needed to be performed, the terminal transmitting the scanning request signaling to the service base station, to request for scanning the carriers of the service base station; or when the between the base stations is needed to be performed, the terminal transmitting the scanning request signaling to the service base station, to request for scanning the carriers of the adjacent base station(s).

In the above, the step that the terminal requests for scanning the carriers of the service base station comprises: the terminal requesting for scanning all the carriers in the service base station; or the terminal requesting for scanning full configuration carriers in the service base station; and the step that the terminal requests for scanning the carriers of the adjacent base station(s) comprises: the terminal requesting for scanning all the carriers in the adjacent base station(s); or the terminal requesting for scanning full configuration carriers in the adjacent base station(s).

By means of the technical solution of the present invention, the problem in the related art that the terminal can not transmit the scanning request to the base station is solved by the terminal transmitting the scanning request signaling to the service base station when the terminal needs to perform the handover, and the terminal can transmit the scanning request signaling as required to request for performing the handover.

Other features and advantages of the present invention will be described in the following description and partly become obvious from the description, or be understood by implementing the present invention. The objects and other advantages of the present invention can be realized and obtained through the structures indicated by the description, claims and drawings.

### BRIEF DESCRIPTION OF THE DRAWINGS

Drawings, provided for further understanding of the present invention and forming a part of the specification, are used to explain the present invention together with embodiments of the present invention rather than to limit the present invention, wherein

FIG. 1 is a flow chart of a method for transmitting a scanning request based on a multicarrier system according to method embodiment 1 of the present invention;

FIG. 2 is a flow chart of Example 1 according to the embodiments of the present invention;

FIG. 3 is a flow chart of Example 2 according to the embodiments of the present invention;

FIG. 4 is a flow chart of a method for transmitting a scanning request based on a multicarrier system according to method embodiment 2 of the present invention;

FIG. 5 is a flow chart of Example 3 according to the embodiments of the present invention;

FIG. 6 is a flow chart of Example 4 according to the embodiments of the present invention;

FIG. 7 is a flow chart of a method for transmitting a scanning request based on a multicarrier system according to method embodiment 3 of the present invention.

### DETAILED DESCRIPTION OF EMBODIMENTS

### Function Overview

In the related art of a multicarrier system, when a service carrier can not provide good wireless conditions for a terminal, the terminal has no related solution to transmit a scanning request to the service base station. For this reason, the present invention provides an improved solution for transmitting the scanning request based on the multicarrier system. In the technical solution of the present invention, the service base station which supports the multicarrier broadcasts all the carrier information of the service base station and adjacent base station(s) to the terminal; when the service carrier can not provide good wireless conditions for the terminal, the terminal transmits a scanning request signaling to the service base station, to request for performing the scanning. It should be explained that the base station described in the embodiments of the present invention is the service base station which provides services for the terminal.

The preferred embodiments of the present invention will be described hereinafter in connection with the drawings. It should be understood that the preferred embodiments described herein are only used to illustrate and explain the present invention without limiting the present invention.

In the following description, for the purpose of explanation, multiple specific details are described to provide thorough understanding to the present invention. However, obviously, the present invention can also be implemented under a circumstance without the specific details. In addition, under the circumstance without deviating from the spirit and range explained by the accompanying Claims, the following embodiments and details in the embodiments can combine with each other.

### Method Embodiment 1

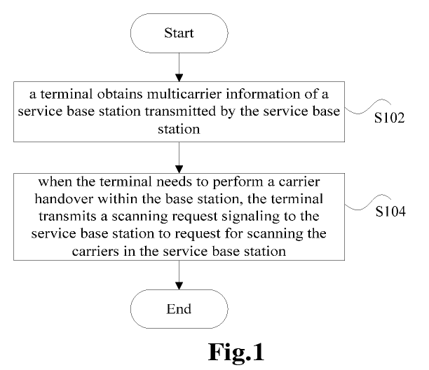

A method for transmitting a scanning request based on a multicarrier system is provided according to the embodiments of the present invention. FIG. 1 is a flow chart of the method for transmitting the scanning request based on the multicarrier system according to method embodiment 1 of the present invention. As shown in FIG. 1, the method comprises the process as follows (step S102-step S104).

Step S102, a terminal obtains multicarrier information of a service base station transmitted by the service base station. Specifically, the multicarrier information can be transmitted to the terminal by the service base station via an MOB_SMC-ADV message, wherein at least one of the following parameters are carried in the MOB_SMC-ADV message: a number of carriers of the base station, a full configuration carrier indicator, a number of full configuration carriers of the base station, a carrier identifier, carrier frequency, and carrier bandwidth.

Step S104, when the terminal needs to perform a carrier handover within the base station, for example, when a service carrier can not provide good wireless conditions for the terminal, or when intensity of signals of the service carrier is reduced and the terminal needs to search carriers with better intensity, the terminal transmits a scanning request signaling to the service base station, to request the service base station to allocate a period of scanning time. Then the terminal can scan the carriers in the service base station according to the multicarrier information within the scanning time allocated by the service base station. It should be noted that the terminal may scan all the carriers in the service base station or full configuration carriers in the service base station.

Specifically, when the terminal transmits to the service base station a request for scanning the other carriers of the service base station, the request can be transmitted via an MOB_SCN-REQ message or a new message (MOB_SMC-REQ message). In addition, when the scanning request signaling is transmitted, the terminal also needs to add parameters which are necessary when the terminal scans the carriers of the base station into the MOB_SCN-REQ message or the MOB_SMC-REQ message, for example, the parameters such as scan duration, interleaving interval, scan iteration, a number index of carriers of recommended service base station, bitmap size of the carriers of the service base station, a bitmap index of the carriers of the service base station, and an index of the carriers of the service base station.

It can be concluded from the above description that two situations as follows exist when the terminal transmits the scanning request signaling to the service base station.

Situation 1, the scanning request signaling is transmitted by the MOB_SCN-REQ message. The MOB_SCN-REQ message itself has already carried the information such as the scan duration, the interleaving interval, and the scan iteration, the MOB_SCN-REQ message only needs to be added with the following parameters: the number index of recommended carriers, the bitmap size of the carriers, the bitmap index of the carriers, and the index of the carriers.

Situation 2, the scanning request signaling is transmitted via the new message (MOB_SMC-REQ message). The MOB_SMC-REQ message must carry the following parameters: the scan duration, the interleaving interval, the scan iteration, the number index of recommended carriers, the bitmap size of the carriers, the index bitmap of the carriers, and the index of the carriers.

After the step S104, the service base station will receive the scanning request signaling transmitted by the terminal. After the service base station receives the scanning request signaling, the service base station first determines whether the terminal can start scanning the carriers according to information such as a current state of the terminal and/or an internal dispatch algorithm of the base station. When service base station determines that the terminal can start scanning the carriers, the service base station transmits a scanning response message to the terminal, and carries the scanning time allocated to the terminal in the scanning response message. After receiving the scanning response message, the terminal scans the carriers of the service base station within the scanning time allocated by the service base station according to the scanning response message transmitted by the service base station.

The process in the situation 1 and the situation 2 will be respectively explained hereinafter in connection with the drawings.

### Example 1

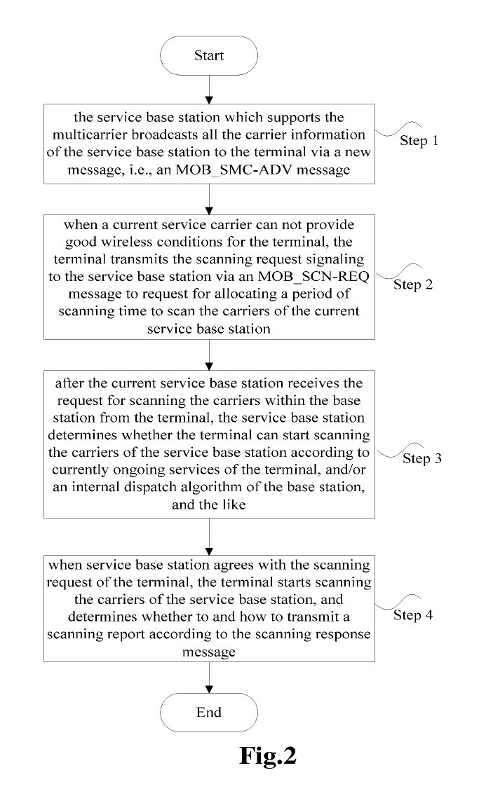

The process in the present Example will be explained hereinafter by taking the situation 1 as an example. In the present example, the multicarrier information is transmitted to the terminal by the service base station via the MOB_SMC-ADV message, and the scanning request signaling is transmitted to the service base station by the terminal via the original MOB_SCN-REQ message. FIG. 2 is a flow chart of Example 1 according to the embodiments of the present invention. As shown in FIG. 2, the method comprises the process as follows (step 1-step 4).

Step 1, the service base station which supports the multicarrier broadcasts all the carrier information (the above multicarrier information) of the service base station to the terminal. Specifically, the multicarrier information of the service base station can be carried in the MOB_SMC-ADV message. The MOB_SMC-ADV message is a new message, is a system message about internal carrier information of the base station, and may be broadcasted to terminals in service area of the service base station by the service base station via a broadcast channel. Table 1 shows the format of the MOB_SMC-ADV message which supports the multicarrier, wherein the multicarrier information in the message includes but not limited to following parameters: the number of the carriers contained in a multicarrier cell, the carrier identifier (SCID), the carrier frequency (SCF), and the carrier bandwidth (SCB) (corresponding to step S102 in FIG. 1).

The following parameters need to be added in the MOB_SCN-REQ message: 1, the number of the multicarrier of the current base station (N_SCARRIERS), 2, a full configuration carrier indicator or not (SFC flag), 3, the number of the full configuration carriers of the current base station (N_SFCARRIERS).

TABLE 1

| Syntax | Size (bit) | Notes |
|---|---|---|
| MOB_SMC-ADV_Message_format | — | — |
| ( ) { | | |
| Total Fragmentation | 4 | Total number of fragmentation |
| N_SCARRIERS | 8 | — |
| For (j = 0; j < N_SCARRIERS; | — | — |
| j++){ | | |
| Length | 8 | information lengths of all vectors |
| | | contained in a FOR loop |
| SFC flag | 1 | when the SFC flag equals to 1, the |
| | | carrier is the full configuration |
| | | carrier; when the SFC flag equals to |
| | | 0, the carrier is the partial |
| | | configuration carrier. |
| If (SFC flag == 1) { | — | — |
| N_SFCARRIERS | 3 | — |
| For (j = 0; j < N_SFCARRIERS; | — | — |
| j++){ | | |
| SCID | 8 | — |
| SCF | 8 | — |
| SCB | 8 | — |
| } | — | — |
| } | — | — |
| Else{ | | |
| SCID | 8 | — |
| SCF | 8 | — |
| SCB | 8 | — |
| } | — | — |
| } | — | — |
| } | — | — |

Step 2, when the service carrier can not provide good wireless conditions for the terminal, the terminal transmits the scanning request signaling to the service base station to request for allocating a period of scanning time to scan the carriers of the current service base station. Specifically, when the terminal transmits to the service base station the scanning request signaling for scanning the carriers of the service base station, the scanning request signaling can be transmitted by being carried in the MOB_SCN-REQ message. Table 2 shows a format of the MOB_SCN-REQ message which supports the multicarrier. As shown in table 2, the MOB_SCN-REQ message can carry the following parameters: 1, the number index of the carriers of the recommended service base station (N_Recommended_SMC_Index), wherein if the value of the N_Recommended_SMC_Index equals to 0xFF, the bitmap index of the carriers of the service base station (SMC_Bitmap_Index) needs to be used to identify the index of the carriers of the service base station (SMC_BS_Index) in the MOB_SMC-ADV message; if the value of the N_Recommended_SMC_Index does not equal to 0xFF, the N_Recommended_SMC_Index means the number of recommended carriers in the MOB_SMC-ADV message, 2, the bitmap size of the carriers of the service base station (SMC_Bitmap_Size), which is used for representing the index size of the bitmap of the full configuration carrier of the service base station, 3, the bitmap index of the carriers of the service base station (SMC_Bitmap_Index), which is used for representing the bitmap index of the full configuration carrier of the service base station, and 4, the index of the carriers of the service base station (SMC_BS_Index), which is used for representing a index of location of the carriers of the service base station in the MOB_SMC-ADV message (corresponding to the step S104 in FIG. 1).

TABLE 2

| Syntax | Size (bit) | Notes |
|---|---|---|
| ... | ... | ... |
| Scan Iteration | 8 | — |
| N_Recommended_SMC_Index | 8 | If the value thereof does not equal to 0xFF, |
| | | the N_Recommended_SMC_Index means |
| | | the number of the recommended carriers in |
| | | the MOB_SMC-ADV message; and if the |
| | | value thereof equals to 0xFF, the |
| | | SMC_Bitmap_Index will be used to |
| | | identify the index of the carriers of the |
| | | service base station in the |
| | | MOB_SMC-ADV message. |
| If(N_Recommended_SMC_Index | | |
| != 0){ | | |
| Configuration Change | 8 | |
| Count for | | |
| MOB_NBR-ADV message | | |
| } | — | — |
| If(N_Recommended_SMC_Index | — | — |
| == 0xFF){ | | |
| Reserved | 1 | The Reserved can be set as 0 |
| Req_Seq_Num | 1 | One digit serial number of a message |
| | | associated with each new message. |
| SMC_Bitmap_Size | 6 | The size thereof is less than or equals to the |
| | | number of the carriers of the service base |
| | | station in the MOB_SMC-ADV message. |
| SMC_Bitmap_Index | (SMC_Bitmap_Size + | 0: the corresponding multicarrier is not |
| | 1) × 4 | requested; |
| | | 1: the corresponding multicarrier is |
| | | requested. |
| for ( each ‘1’ in | — | — |
| Nbr_Bitmap_Index){ | | |
| Reserved | 1 | The Reserved can be set as 0 |
| Scanning_type | 1 | 0b000: scanning with no association; |
| | | 0b001: scanning with association in layer 0; |
| | | 0b010: scanning with association in layer 1; |
| | | 0b011: scanning with association in layer 2; |
| | | 0b100-0b111: reserved |
| } | — | — |
| } else { | — | — |
| for (j = 0; j < | — | — |
| N_Recommended_SMC_Index | | |
| ; j++){ | | |
| SMC_BS_Index | 8 | Index of the corresponding location of the |
| | | carriers of the service base station in the |
| | | MOB_SMC-ADV message |
| Req_Seq_Num | 1 | One digit serial number of the message |
| | | associated with each new message. |
| Scanning_type | 1 | 0b000: scanning with no association; |
| | | 0b001: scanning with association in layer 0; |
| | | 0b010: scanning with association in layer 1; |
| | | 0b011: scanning with association in layer 2; |
| | | 0b100-0b111: reserved |
| } | | |
| } | — | — |
| N_Recommended_BS_Index | 8 | If the value does not equal to 0xFF, the |
| | | N_Recommended_BS_Index means the |
| | | number of the recommended base stations |
| | | in the MOB_NBR-ADV message; and if the |
| | | value equals to 0xFF, the BS_Bitmap_Index |
| | | will be used to identify the index of the base |
| | | station in the MOB_NBR-ADV message. |
| ... | ... | ... |
| } | — | — |

Step 3, after the service base station receives the MOB_SCN-REQ message which carries the scanning request signaling from the terminal, the service base station determines whether the terminal can start scanning the carriers of the service base station according to currently ongoing services of the terminal, and/or the internal dispatch algorithm of the base station, and the like.

Step 4, when service base station determines that the terminal can start scanning the carriers of the service base station, the service base station transmits the scanning response message to the terminal. The terminal starts scanning the carriers of the service base station, and determines whether to and how to transmit a scanning report to the base station according to the scanning response message.

By the above-mentioned process, when the terminal needs to perform the carrier handover within the base station, the terminal can transmit the scanning request signaling to the base station via the MOB_SCN-REQ message.

### Example 2

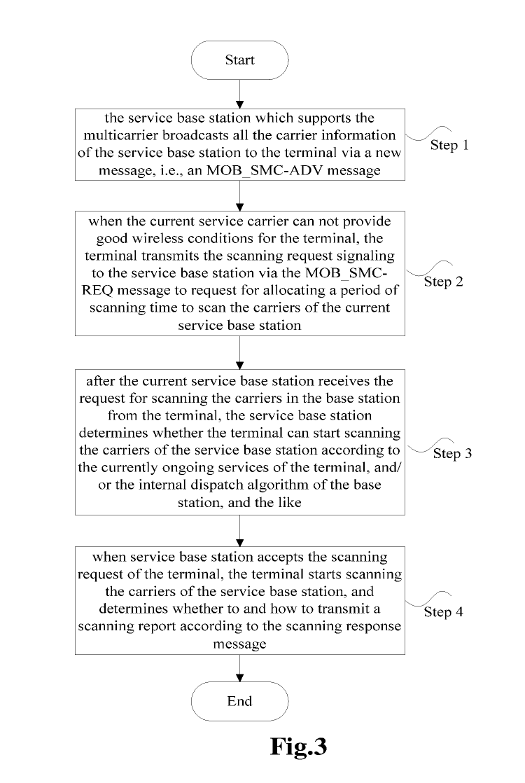

The process in the present example will be explained hereinafter by taking situation 2 as an example. In the present example, the multicarrier information is transmitted to the terminal by the service base station via the MOB_SMC-ADV message, and the scanning request signaling is transmitted to the service base station by the terminal via a newly added MOB_SMC-REQ message. FIG. 3 is a flow chart of Example 2 according to the embodiments of the present invention. As shown in FIG. 3, the method comprises the process as follows (step 1-step 4).

Step 1, the service base station which supports the multicarrier broadcasts all the carrier information of the service base station to the terminal. Specifically, the multicarrier information of the service base station can be carried in the MOB_SMC-ADV message. The MOB_SMC-ADV message, which is a new message, is a system message about internal carrier information of the base station, and can be broadcasted to terminals in service area of the service base station by the service base station via a broadcast channel. The format of the MOB_SMC-ADV message which supports the multicarrier can refer to Table 1, wherein the multicarrier information in the message includes but not limited to the following parameters: the number of the carriers contained in the multicarrier cell, the carrier identifier (SCID), the carrier frequency (SCF), and the carrier bandwidth (SCB) (corresponding to the step S102 in FIG. 1).

In addition, the MOB_SMC-ADV message shown in Table 1 may also be added with the following parameters: 1, the number of the multicarrier of the current base station (N_SCARRIERS), 2, a full configuration carrier indicator or not (SFC flag), 3, the number of the full configuration carriers of the current base station (N_SFCARRIERS).

Step 2, when the current service carrier can not provide good wireless conditions for the terminal, the terminal transmits the scanning request signaling to the service base station, to request for allocating a period of time to scan the carriers of current service base station. Specifically, when the terminal transmits to the service base station the scanning request signaling for scanning the carriers of the service base station, the scanning request signaling can be transmitted via the newly added MOB_SMC-REQ message to request for allocating scan interval and scan estimated time or recommending a starting frame. The MOB_SMC-REQ message is a new message; and Table 3 shows the format of the MOB_SMC-REQ message which supports the multicarrier. As shown in Table 3, the MOB_SMC-REQ message may carry the following parameters: 1, the scan duration, 2, the interleaving interval, 3, the scan iteration, 4, the N_Recommended_SMC_Index, wherein if the value of the N_Recommended_SMC_Index equals to 0xFF, the SMC_Bitmap_Index will be used to identify the index of the carriers of the service base station in the MOB_SMC-ADV message; and if the value of the N_Recommended_SMC_Index does not equal to 0xFF, the N_Recommended_SMC_Index means the number of recommended carriers in the MOB_SMC-ADV message, 5, the SMC_Bitmap_Size, which is used for representing the index size of bitmap of the full configuration carrier of the service base station, 6, the SMC_Bitmap_Index, which is used for representing the bitmap index of the full configuration carrier of the service base station, and 7, the SMC_BS_Index, which is used for representing the location index of the carriers of the service base station in the MOB_SMC-ADV message (corresponding to the step S104 in FIG. 1).

TABLE 3

| Syntax | Size (bit) | Notes |
|---|---|---|
| MOB_SMC-ADV_Message_format( ) | — | — |
| { | | |
| Scan duration | 8 | — |
| Interleaving interval | 8 | — |
| Scan Iteration | 8 | — |
| N_Recommended_SMC_Index | 8 | If the value does not equal to 0xFF, the |
| | | N_Recommended_SMC_Index means the |
| | | number of the recommended carriers in the |
| | | MOB_SMC-ADV message; and if the value |
| | | equals to 0xFF, the SMC_Bitmap_Index is |
| | | used to identify the SMC_BS_Index in the |
| | | MOB_SMC-ADV message. |
| If(N_Recommended_SMC_Index | | |
| != 0){ | | |
| Configuration Change Count | 8 | |
| for MOB_SMC-ADV | | |
| message | | |
| } | — | — |
| If(N_Recommended_SMC_Index | — | — |
| == 0xFF){ | | |
| Reserved | 1 | The Reserved can be set as 0 |
| Req_Seq_Num | 1 | One digit serial number of the message |
| | | associated with each new message. |
| SMC_Bitmap_Size | 6 | The size is less than or equals to the number |
| | | of the carriers of the service base station in |
| | | MOB_SMC-ADV message. |
| SMC_Bitmap_Index | (SMC_Bitmap_Size + | 0: the corresponding multicarrier is not |
| | 1) × 4 | requested; |
| | | 1: the corresponding multicarrier is |
| | | requested. |
| for ( each ‘1’ in | — | — |
| Nbr_Bitmap_Index){ | | |
| Reserved | 1 | The Reserved can be set as 0 |
| Scanning_type | 1 | 0b000: scanning with no association; |
| | | 0b001: scanning with association in layer 0; |
| | | 0b010: scanning with association in layer 1; |
| | | 0b011: scanning with association in layer 2; |
| | | 0b100-0b111: reserved |
| } | — | — |
| } else { | — | — |
| for (j = 0; j < | — | — |
| N_Recommended_SMC_Index | | |
| ; j++){ | | |
| SMC_BS_Index | 8 | Index of the corresponding location of the |
| | | carriers of the service base station in the |
| | | MOB_SMC-ADV message. |
| Req_Seq_Num | 1 | One digit serial number of the message |
| | | associated with each new message. |
| Scanning_type | 1 | 0b000: scanning with no association; |
| | | 0b001: scanning with association in layer 0; |
| | | 0b010: scanning with association in layer 1; |
| | | 0b011: scanning with association in layer 2; |
| | | 0b100-0b111: reserved |
| } | | |
| } | — | — |
| } | — | — |

Step 3, after the service base station receives the MOB_SMC-REQ message which carries the scanning request signaling from the terminal, the service base station determines whether the terminal can start scanning the carriers of the service base station according to currently ongoing services of the terminal, and/or the internal dispatch algorithm of the base station, and the like.

Step 4, when service base station determines that the terminal can start scanning the carriers of the service base station, the service base station transmits the scanning response message to the terminal. The terminal starts scanning the carriers of the service base station, and determines whether to and how to transmit a scanning report to the base station according to the scanning response message.

By the above-mentioned process, when the terminal needs to perform the carrier handover within the base station, the terminal can transmit the scanning request signaling to the base station via the newly added MOB_SMC-REQ message.

### Method Embodiment 2

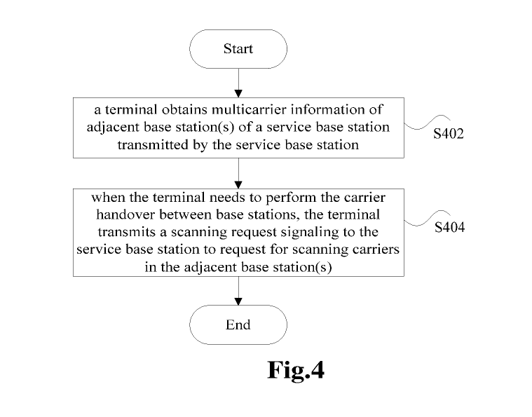

A method for transmitting a scanning request based on a multicarrier system is provided according to the embodiments of the present invention. FIG. 4 is a flow chart of the method for transmitting the scanning request based on the multicarrier system according to method embodiment 2 of the present invention. As shown in FIG. 4, the method comprises the process as follows (step S402-step S404).

Step S402, a terminal obtains multicarrier information of adjacent base station(s) of a service base station transmitted by the service base station. Specifically, the multicarrier information can be transmitted to the terminal by the service base station via a MOB_NBR-ADV message, wherein the MOB_NBR-ADV message carries at least one of the following parameters: an identifier of the adjacent bases station(s), a preamble index/sub-channel index, whether co-location flag, a time frequency synchronization flag, an SFC flag, number of carriers, a carrier identifier, carrier frequency, and carrier bandwidth.

Step S404, when the terminal needs to perform the carrier handover between base stations, for example, when a service carrier can not provide good wireless conditions for the terminal, or when intensity of signals of the service carrier is reduced and the terminal needs to search carriers with better intensity, the terminal transmits a scanning request signaling to the service base station, to request the service base station to allocate a period of scanning time. Then the terminal can scan the carriers in the service base station according to the multicarrier information within the scanning time allocated by the service base station. It should be noted that the terminal may scan all the carriers in the service base station or full configuration carriers in the service base station.

Specifically, when the terminal transmits to the service base station a request for scanning the other carriers of the service base station, the request can be transmitted via an MOB_SCN-REQ message or a new message (MOB_SMC-REQ message). In addition, when the scanning request signaling is transmitted, the terminal also needs to add parameters which are necessary when the terminal scans the carriers of the base station into the MOB_SCN-REQ message or the MOB_SMC-REQ message, for example, the parameters such as scan duration, interleaving interval, scan iteration, an N_Recommended_SMC_Index, an SMC_Bitmap_Size, an SMC_Bitmap_Index, and an SMC_BS_Index.

It can be concluded from the above description that two situations as follows exist when the terminal transmits the scanning request signaling to the service base station.

Situation 1, the scanning request signaling is transmitted by the MOB_SCN-REQ message. The MOB_SCN-REQ message itself has already carried the information such as scan duration, interleaving interval, and scan iteration, the MOB_SCN-REQ message only needs to be added with the following parameters: a number index of recommended carriers, bitmap size of the carriers, a bitmap index of the carriers, and an index of the carriers.

Situation 2, the scanning request signaling is transmitted via the new message (MOB_SMC-REQ message). The MOB_SMC-REQ message must carry the following parameters: the scan duration, the interleaving interval, the scan iteration, the number index of recommended carriers, the bitmap size of the carriers, the index of the bitmap of the carriers, and the index of the carriers.

After the step S104, the service base station will receive the scanning request signaling transmitted by the terminal. After the service base station receives the scanning request signaling, the service base station first determines whether the terminal can start scanning the carriers according to information such as a current state of the terminal and/or an internal dispatch algorithm of the base station. When service base station determines that the terminal can start scanning the carriers, the service base station transmits a scanning response message to the terminal, and carries the scanning time allocated to the terminal in the scanning response message. After receiving the scanning response message, the terminal scans the carriers of the service base station within the scanning time allocated by the service base station according to the scanning response message transmitted by the service base station.

The process in the situation 1 and the situation 2 will be respectively explained hereinafter in connection with the drawings.

### Example 3

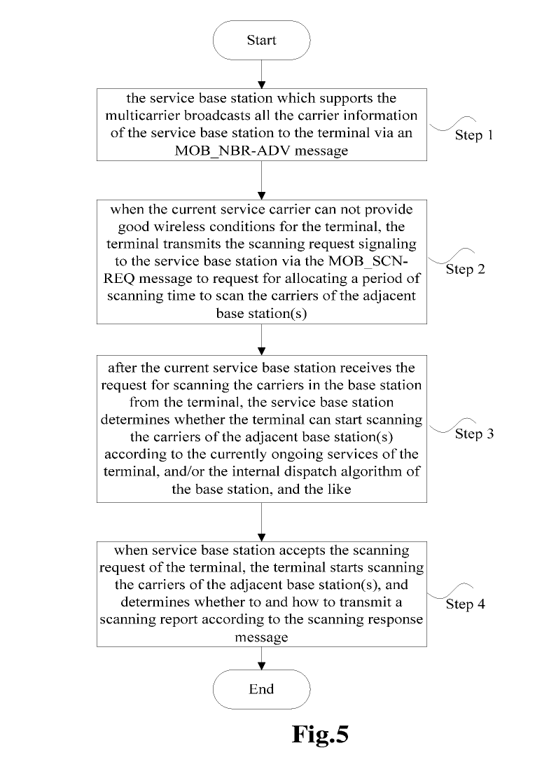

The process in the present example will be explained hereinafter by taking the situation 1 as an example. In the present example, the multicarrier information is transmitted to the terminal by the service base station via the MOB_NBR-ADV message, and the scanning request signaling is transmitted to the service base station by the terminal via the original MOB_SCN-REQ message. FIG. 5 is a flow chart of Example 3 according to the embodiments of the present invention. As shown in FIG. 5, the process comprises the process as follows (step 1-step 4).

Step 1, the service base station which supports the multicarrier broadcasts all the carrier information (the above multicarrier information) of the adjacent base station(s) to the terminal. Specifically, the multicarrier information of the adjacent base station(s) can be carried in the MOB_NBR-ADV message. Table 4 shows the format of the MOB_NBR-ADV message which supports the multicarrier; as shown in Table 4, the multicarrier information in the message includes but not limited to the following parameters: the identifier of the adjacent base station(s), the preamble index/sub-channel index, whether co-location flag, the time frequency synchronization flag, the SFC flag, the number of carriers contained in a multicarrier cell, the carrier identifier (SCID), the carrier frequency (SCF), and the carrier bandwidth (SCB) (corresponding to the step S402 in FIG. 4).

TABLE 4

| Syntax | Size (bit) | Notes |
|---|---|---|
| ... | ... | ... |
| N_NEIGHBORS | 8 | — |
| For (j = 0 ; j < | — | — |
| N_NEIGHBORS; j++){ | | |
| Length | 8 | information lengths of all vectors |
| | | contained in a FOR loop. |
| N_CARRIERS | 3 | — |
| For (j = 0 ; j < | — | — |
| N_CARRIERS; j++){ | | |
| FC flag | 1 | If the FC flag equals to 1, the |
| | | carrier is the full configuration |
| | | carrier; and if the FC flag equals |
| | | to 0, the carrier is the partial |
| | | configuration carrier. |
| FID | — | — |
| FF | — | — |
| FB | — | — |
| } | — | — |
| ... | ... | ... |
| } | — | — |
| ... | ... | ... |

Steps 2, when the service carrier can not provide good wireless conditions for the terminal, the terminal transmits the scanning request signaling to the service base station to request for allocating a period of scanning time to scan the carriers of current service base station. Specifically, when the terminal transmits to the service base station the scanning request signaling for scanning the carriers of the service base station, the scanning request signaling can be transmitted by being carried in the MOB_SCN-REQ message. Table 5 shows the format of the MOB_SCN-REQ message which supports the multicarrier. As shown in table 5, the MOB_SCN-REQ message can carry the following parameters: 1, the number index of the carriers of the recommended adjacent base station(s) (N_Recommended_SMC_Index), wherein if the value of the N_Recommended_SMC_Index equals to 0xFF, the SMC_Bitmap_Index needs to be used to identify an index of the carriers of the adjacent base station(s) in the MOB_NBR-ADV message; and if the value of the N_Recommended_SMC_Index does not equal to 0xFF, the N_Recommended_SMC_Index means the number of the recommended carriers in the MOB_NBR-ADV message, 2, the bitmap size of the carriers of the adjacent base station(s) (SMC_Bitmap_Size), which is used for representing the index size of the bitmap of the full configuration carrier of the adjacent base station(s), 3, the bitmap index of the carriers of the adjacent base station(s) (SMC_Bitmap_Index), which is used for representing the bitmap index of the full configuration carrier of the adjacent base station(s), and 4, the index of the carriers of the adjacent base station (SMC_BS_Index), which is used for representing the location index of the carriers of the adjacent base station(s) in the MOB_NBR-ADV message (corresponding to the step S404 in FIG. 4).

TABLE 5

| Syntax | Size (bit) | Notes |
|---|---|---|
| ... | ... | ... |
| Scan Iteration | 8 | — |
| N_Recommended_SMC_Index | 8 | If the value does not equal to 0xFF, the |
| | | N_Recommended_SMC_Index means the |
| | | number of the recommended carriers in the |
| | | MOB_NBR-ADV message; and if the |
| | | value equals to 0xFF, the |
| | | SMC_Bitmap_Index will be used to |
| | | identify the index of the carriers of the |
| | | service base station in the |
| | | MOB_NBR-ADV message. |
| If(N_Recommended_SMC_Index | | |
| != 0){ | | |
| Configuration Change Count | 8 | |
| for MOB_NBR-ADV | | |
| message | | |
| } | — | — |
| If(N_Recommended_SMC_Index | — | — |
| == 0xFF){ | | |
| Reserved | 1 | The Reserved can be set as 0 |
| Req_Seq_Num | 1 | One digit serial number of a message |
| | | associated with each new message. |
| SMC_Bitmap_Size | 6 | The size is less than or equals to the |
| | | number of the carriers of the service base |
| | | station in MOB_NBR-ADV message. |
| SMC_Bitmap_Index | (SMC_Bit | 0: the corresponding multicarrier is not |
| | map_Size + 1) × 4 | requested; |
| | | 1: the corresponding multicarrier is |
| | | requested. |
| for ( each ‘1’ in | — | — |
| Nbr_Bitmap_Index){ | | |
| Reserved | 1 | The Reserved can be set as 0 |
| Scanning_type | 1 | 0b000: scanning with no association; |
| | | 0b00l: scanning with association in layer q; |
| | | 0b010: scanning with association in layer |
| | | 1; |
| | | 0b011: scanning with association in layer |
| | | 2; |
| | | 0bl00-0b111: reserved |
| } | — | — |
| } else { | — | — |
| for (j = 0; j < | — | — |
| N_Recommended_SMC_Index | | |
| ; j++){ | | |
| SMC_BS_Index | 8 | Index of the corresponding location of the |
| | | carriers of the service base station in the |
| | | MOB_NBR-ADV message |
| Req_Seq_Num | 1 | One digit serial number of the message |
| | | associated with each new message. |
| Scanning_type | 1 | 0b000: scanning with no association; |
| | | 0b00l: scanning with association in layer 0; |
| | | 0b010: scanning with association in layer |
| | | 1; |
| | | 0b011: scanning with association in layer |
| | | 2; |
| | | 0bl00-0b111: reserved |
| } | | |
| } | — | — |
| N_Recommended_BS_Index | 8 | If the value does not equal to 0xFF, the |
| | | N_Recommended_BS_Index means the |
| | | number of recommended base stations in |
| | | the MOB_NBR-ADV message; and if the |
| | | value equals to 0xFF, the |
| | | BS_Bitmap_Index will be used to identify |
| | | the index of the base staion in the |
| | | MOB_NBR-ADV message. |
| ... | ... | ... |
| } | — | — |

Step 3, after the service base station receives the MOB_SCN-REQ message which carries the scanning request signaling from the terminal, the service base station determines whether the terminal can start scanning the carriers of the service base station according to currently ongoing services of the terminal, and/or the internal dispatch algorithm of the base station, and the like.

Step 4, when service base station determines that the terminal can start scanning the carriers of the service base station, the service base station transmits the scanning response message to the terminal. The terminal starts scanning the carriers of the service base station, and determines whether to and how to transmit a scanning report to the base station according to the scanning response message.

By the above-mentioned process, when the terminal needs to perform the carrier handover between the base stations, the terminal can transmit the scanning request signaling to the base station via the MOB_SCN-REQ message.

### Example 4

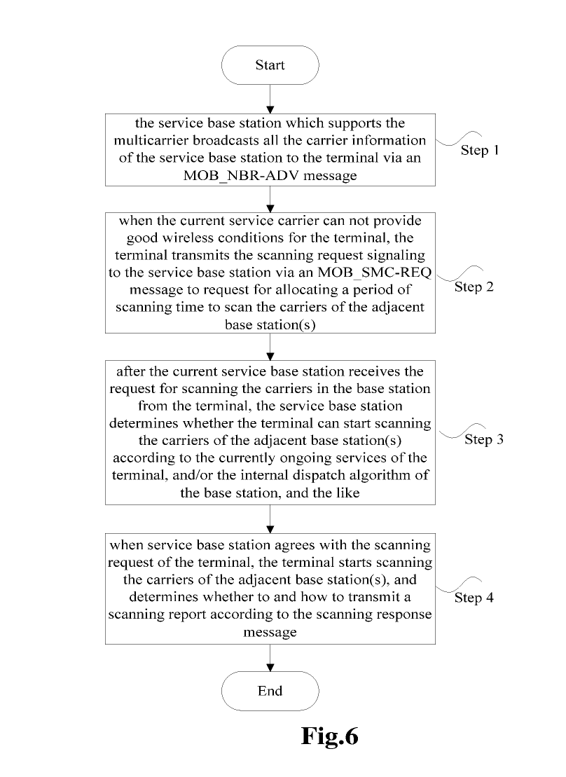

The process in the present example will be explained hereinafter by taking situation 2 as an example. In the present example, the multicarrier information is transmitted to the terminal by the service base station via the MOB_NBR-ADV message, and the scanning request signaling is transmitted to the service base station by the terminal via a newly added MOB_SMC-REQ message. FIG. 6 is a flow chart of Example 4 according to the embodiments of the present invention. As shown in FIG. 6, the method comprises the process as follows (step 1-step 4).

Step 1, the service base station, which supports the multicarrier, broadcasts all the carrier information (the above multicarrier information) of the adjacent base station(s) to the terminal. Specifically, the multicarrier information of the adjacent base station(s) can be carried in the MOB_NBR-ADV message. Table 4 shows the format of the MOB_NBR-ADV message which supports the multicarrier, wherein the multicarrier information in the message includes but not limited to the following parameters: the identifier of the adjacent bases station(s), the preamble index/sub-channel index, whether co-location flag, the time frequency synchronization flag, the SFC flag, the number of carriers contained in a multicarrier cell, the carrier identifier (SCID), the carrier frequency (SCF), and the carrier bandwidth (SCB) (corresponding to the step S402 in FIG. 4).

Step 2, when the service carrier can not provide good wireless conditions for the terminal, the terminal transmits the scanning request signaling to the service base station to request for allocating a period of scanning time to scan the carriers of current service base station. Specifically, when the terminal transmits the scanning request signaling to the service base station for scanning the carriers of the service base station, the scanning request signaling can be transmitted via the newly added MOB_SMC-REQ message to request for allocating the scan interval, the scan estimated time or recommending the starting frame. The MOB_SMC-REQ message is a new message; and Table 6 shows the format of the MOB_SMC-REQ message which supports the multicarrier. As shown in Table 6, the MOB_SMC-REQ message can carry the following parameters: 1, the scan duration, 2, the interleaving interval, 3, the scan iteration, 4, the N_Recommended_SMC_Index, wherein if the value of the N_Recommended_SMC_Index equals to 0xFF, the SMC_Bitmap_Index will be used to identify the index of the carriers of the adjacent base station(s) in the MOB_NBR-ADV message; and if the value of the N_Recommended_SMC_Index does not equal to 0xFF, the N_Recommended_SMC_Index means the number of the recommended carriers in the MOB_NBR-ADV message, 5, the SMC_Bitmap_Size, which is used for representing the index size of the bitmap of the full configuration carrier of the adjacent base station(s), 6, the SMC_Bitmap_Index, which is used for representing the bitmap index of the full configuration carrier of the adjacent base station(s), and 7, the index of carrier the adjacent base station(s) (SMC_BS_Index), which is used for representing the location index of the carriers of the adjacent base station(s) in the MOB_NBR-ADV message (corresponding to the step S404 in FIG. 4).

TABLE 6

| Syntax | Size (bit) | Notes |
|---|---|---|
| MOB_SMC-ADV_Message_format( ) | — | — |
| { | | |
| Scan duration | 8 | — |
| Interleaving interval | 8 | — |
| Scan Iteration | 8 | — |
| N_Recommended_SMC_Index | 8 | If the value does not equal to 0xFF, the |
| | | N_Recommended_SMC_Index means the |
| | | number of the recommended carriers in the |
| | | MOB_NBR-ADV message; and if the value |
| | | equals to 0xFF, the SMC_Bitmap_Index |
| | | will be used to identify the index of the |
| | | carriers of the service base station in the |
| | | MOB_NBR-ADV message. |
| If(N_Recommended_SMC_Index | | |
| != 0){ | | |
| Configuration Change Count | 8 | |
| for MOB_SMC-ADV | | |
| message | | |
| } | — | — |
| If(N_Recommended_SMC_Index | — | — |
| == 0xFF){ | | |
| Reserved | 1 | The Reserved can be set as 0 |
| Req_Seq_Num | 1 | One digit serial number of the message |
| | | associated with each new message. |
| SMC_Bitmap_Size | 6 | The size is less than or equals to the number |
| | | of the carriers of the service base station in |
| | | the MOB_NBR-ADV message. |
| SMC_Bitmap_Index | (SMC_Bitmap_Size + | 0: the corresponding multicarrier is not |
| | 1) × 4 | requested; |
| | | 1: the corresponding multicarrier is |
| | | requested. |
| for (each ‘1’ in | — | — |
| Nbr_Bitmap_Index){ | | |
| Reserved | 1 | The Reserved can be set as 0 |
| Scanning_type | 1 | 0b000: scanning with no association; |
| | | 0b00l: scanning with association in layer 0; |
| | | 0b010: scanning with association in layer 1; |
| | | 0b011: scanning with association in layer 2; |
| | | 0bl00-0b111: reserved |
| } | — | — |
| } else { | — | — |
| for (j = 0; j < | — | — |
| N_Recommended_SMC_Index | | |
| ; j++){ | | |
| SMC_BS_Index | 8 | Index of the corresponding location of the |
| | | carriers of the service base station in the |
| | | MOB_NBR-ADV message. |
| Req_Seq_Num | 1 | One digit serial number of the message |
| | | associated with each new message. |
| Scanning_type | 1 | 0b000: scanning with no association; |
| | | 0b00l: scanning with association in layer 0 |
| | | 0b010: scanning with association in layer 1; |
| | | 0b011: scanning with association in layer 2; |
| | | 0bl00-0b111: reserved |
| } | | |
| } | — | — |
| } | — | — |

Step 3, after the service base station receives the MOB_SCN-REQ message which carries the scanning request signaling from the terminal, the service base station determines whether the terminal can start scanning the carriers of the adjacent base station according to currently ongoing services of the terminal, and/or the internal dispatch algorithm of the base station, and the like.

Step 4, when service base station determines that the terminal can start scanning the carriers of the adjacent base station, the service base station transmits the scanning response message to the terminal. The terminal starts scanning the carriers of the adjacent base station, and determines whether to and how to transmit a scanning report to the base station according to the scanning response message.

By the above-mentioned process, when the terminal needs to perform the carrier handover between the base stations, the terminal can transmit the scanning request signaling to the service base station via the newly added MOB_SMC-REQ message.

### Method Embodiment 3

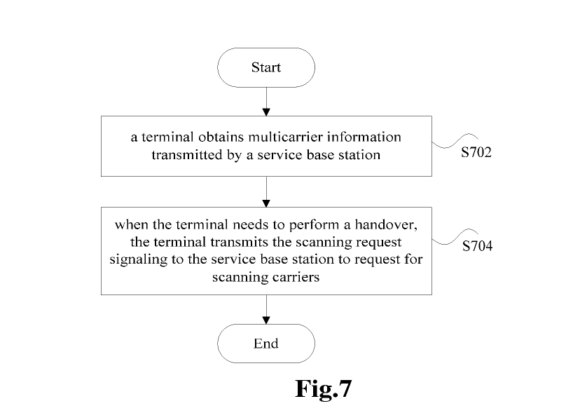

A method for transmitting a scanning request based on a multicarrier system is provided according to the embodiments of the present invention. FIG. 7 is a flow chart of the method for transmitting the scanning request based on the multicarrier system according to the method embodiment 3 of the present invention. As shown in FIG. 7, the method comprises the process as follows (step S702-step S704).

Step S702, a terminal obtains multicarrier information transmitted by a service base station.

Specifically, the service base station can transmit the multicarrier information to the terminal via an MOB_NBR-ADV message if the multicarrier information is multicarrier information of adjacent base station(s), wherein the MOB_NBR-ADV message carries at least one of the following parameters: an identifier of the adjacent base station(s), a preamble index/sub-channel index, whether co-location flag, a time frequency synchronization flag, an SFC flag, number of carriers, a carrier identifier, carrier frequency, and carrier bandwidth.

If the multicarrier information is multicarrier information of the service base station, the service base station can transmit the multicarrier information to the terminal via an MOB_SMC-ADV message, wherein the MOB_SMC-ADV message carries at least one of the following parameters: a number of carriers of the base station, a full configuration carrier indicator, a number of full configuration carriers of the base station, a carrier identifier, carrier frequency, and carrier bandwidth.

Step S704, when the terminal needs to perform the carrier handover between base stations, for example, when a service carrier can not provide good wireless conditions for the terminal, or when intensity of signals of the service carrier is reduced and the terminal needs to search carriers with better intensity, the terminal transmits a scanning request signaling to the service base station, to request the service base station to allocate a period of scanning time. Then the terminal can scan the carriers in the adjacent base station(s) according to the multicarrier information within the scanning time allocated by the service base station.

When the terminal needs to perform the handover within the base station, the terminal transmits the scanning request signaling to the service base station to request the service base station to allocate a period of scanning time. Then the terminal can scan the carriers in the service base station according to the multicarrier information within the scanning time allocated by the service base station.

It should be noted that the terminal can scan all the carriers both in the service base station and the adjacent base station(s), and can also scan the full configuration carriers in the service base station and the adjacent base station(s).

Specifically, when the terminal transmits to the service base station the request for scanning the other carriers of the service base station and/or the adjacent base station(s), the request can be transmitted via the MOB_SCN-REQ message or the newly added MOB_SMC-REQ message. In addition, when transmitting the scanning request signaling, the terminal also needs to add parameters which are necessary for the terminal to scan the carriers of the base station into the MOB_SCN-REQ message or the MOB_SMC-REQ message, such as the parameters such as scan duration, interleaving interval, scan iteration, a number index of carriers of recommended service base station, bitmap size of the carriers of the base station, a bitmap index of the carriers of the base station, and an index of the carriers of the base station.

It can be concluded from the above description that two situations as follows exist when the terminal transmits the scanning request signaling to the service base station.

Situation 1, the scanning request signaling is transmitted by the MOB_SCN-REQ message. The MOB_SCN-REQ message itself has already carried the information such as the scan duration, the interleaving interval, and the scan iteration, the MOB_SCN-REQ message only needs to be added with the following parameters: the number index of the recommended carriers, the bitmap size of the carriers, the bitmap index of the carriers, and the index of the carriers.

Situation 2, the scanning request signaling is transmitted via the new message (MOB_SMC-REQ message). The MOB_SMC-REQ message must carry the following parameters: the scan duration, the interleaving interval, the scan iteration, the number index of recommended carriers, the bitmap size of the carriers, the bitmap index of the carriers, and the index of the carriers.

After the step S104, the service base station will receive the scanning request signaling transmitted by the terminal. After the service base station receives the scanning request signaling, the service base station first determines whether the terminal can start scanning the carriers according to information such as a current state of the terminal and/or an internal dispatch algorithm of the base station. When service base station determines that the terminal can start scanning the carriers, the service base station transmits a scanning response message to the terminal, and carries the scanning time allocated to the terminal in the scanning response message. After receiving the scanning response message, the terminal scans the carriers of the service base station and the adjacent base station(s) within the scanning time allocated by the service base station according to the scanning response message transmitted by the service base station.

To sum up, by means of the technical solution of the present invention, the problem in the related art that the terminal can not transmit the scanning request to the base station is solved by the terminal transmitting the scanning request signaling to the service base station when the terminal needs to perform the handover, and the terminal can transmit the scanning request signaling as required to request for performing the handover.

Obviously, those skilled in the art shall understand that individual modules and individual steps of the present invention can be implemented with general computing devices, they may be integrated in a single computing device or distributed in network formed by a plurality of computing devices, optionally, they may be implemented by using program codes executable by computing devices, thus they may be stored in memory devices for execution by the computing devices, or implemented by making them into integrated circuit module respectively, or by making several means or steps in to a single IC. Thus, the present invention is not limited to any particular combination of hardware and software.

Above description is only to illustrate the preferred embodiments but not to limit the present invention. Various alterations and changes to the present invention are apparent to those skilled in the art. The scope defined in claims shall comprise any modification, equivalent substitution and improvement within the spirit and principle of the present invention.

1. A method for transmitting a scanning request based on a multicarrier system, comprising:
a terminal obtaining multicarrier information of a service base station transmitted by the service base station; and
when a carrier handover within a base station is needed to be performed, the terminal transmitting a scanning request signaling to the service base station, to request for scanning carriers of the service base station.

2. The method according to claim 1, wherein the step that the terminal requests for scanning the carriers of the service base station comprises:
the terminal requesting for scanning all the carriers in the service base station; or
the terminal requesting for scanning full configuration carriers in the service base station.

3. The method according to claim 1, wherein the scanning request signaling carries at least one of the followings: scan duration, interleaving interval, scan iteration, a number index of recommended carriers, bitmap size of the carriers, a bitmap index of the carriers, and an index of the carriers.

4. A method for transmitting a scanning request based on a multicarrier system, comprising:
a terminal obtaining multicarrier information of adjacent base station(s) of a service base station transmitted by the service base station; and
when a handover between base stations is needed to be performed, the terminal transmitting a scanning request signaling to the service base station, to request for scanning carriers of the adjacent base station(s).

5. The method according to claim 4, wherein the step that the terminal requests for scanning the carriers of the adjacent base station(s) comprises:
the terminal requesting for scanning all the carriers in the adjacent base station(s); or
the terminal requesting for scanning full configuration carriers in the adjacent base station(s).

6. The method according to claim 4, wherein the scanning request signaling carries at least one of the followings: scan duration, interleaving interval, scan iteration, a number index of recommended carriers, bitmap size of the carriers, a bitmap index of the carriers, and an index of the carriers.

7. A method for transmitting a scanning request based on a multicarrier system, comprising:
a terminal obtaining multicarrier information transmitted by a service base station; and
when a handover is needed to be performed, the terminal transmitting a scanning request signaling to the service base station, to request for scanning carriers.

8. The method according to claim 7, wherein the step that the terminal obtaining the multicarrier information transmitted by the service base station comprises:
the terminal obtaining the multicarrier information of the service base station transmitted by the service base station; and/or
the terminal obtaining the multicarrier information of adjacent base station(s) of the service base station transmitted by the service base station.

9. The method according to claim 7, wherein the step of when the handover is needed to be performed, the terminal transmitting the scanning request signaling to request for scanning the carrier comprises:
when the handover within a base station is needed to be performed, the terminal transmitting the scanning request signaling to the service base station, to request for scanning the carriers of the service base station; or
when the between the base stations is needed to be performed, the terminal transmitting the scanning request signaling to the service base station, to request for scanning the carriers of the adjacent base station(s).

10. The method according to claim 9, wherein
the step that the terminal requests for scanning the carriers of the service base station comprises: the terminal requesting for scanning all the carriers in the service base station; or the terminal requesting for scanning full configuration carriers in the service base station; and
the step that the terminal requests for scanning the carriers of the adjacent base station(s) comprises: the terminal requesting for scanning all the carriers in the adjacent base station(s); or the terminal requesting for scanning full configuration carriers in the adjacent base station(s).
